(19) United States
(12) Patent Application Publication
(10) Pub. No.: US 2003/0093435 A1
(43) Pub. Date: May 15, 2003

(54) Method and system for application level data object synchronization between two or more processes

(76) Inventor: Vijay R. Bandekar, Laguna Niguel, CA (US)

Correspondence Address: Jack J'maev, SUITE 110, 11800 CENTRAL AVE., CHINO, CA, 91710, US

(21) Appl. No.: 10/287,272

(22) Filed: Nov. 2, 2002

Related U.S. Application Data
(60) Provisional application No. 60/332,962, filed on Nov. 5, 2001.

(51) Int. Cl. G06F 7/00

(52) U.S. Cl. 707/103 R

(57) ABSTRACT

Original abstract object in server is synchronized with copy of object used by client process during a communications session. State changes in copy of object trigger conveyance of unique delta message to server. Update to original object is acknowledged to client process.

### RELATED APPLICATIONS

This present application is related to a provisional application serial No. 60/332,962 filed on Nov. 5, 2002 entitled “Method and System for Application Level Data Object Synchronization Between Two or More Processes”, by Bandekar, currently pending, for which the priority date for this application is hereby claimed.

### BACKGROUND OF THE INVENTION

1. Technical Field

This invention pertains generally to the field of data synchronization between two or more processes.

2. Description of the Prior Art

Wired networks generally exhibit higher aggregate bandwidth than their wireless counterparts. One factor that reduces bandwidth is service interruption. Service interruption is defined as a short-term condition that is caused by loss of connectivity and deterioration in signal quality. Another concern with wireless data networks is that of availability. Availability is a longer-term condition. Wireless networks may experience long periods of time when connection to other systems is simply not available. For these reasons, together with the raw cost of airtime, wireless networks may prove to be a cost prohibitive means of connecting hand-held, or other devices to enterprise or global networks.

There have been many attempts to achieve data synchronization in a cost effective and efficient manner. These traditional synchronization techniques rely primarily on file transfers orchestrated by an operating system's file services. These techniques may be referred to as “system-level” synchronization methods. These existing synchronization techniques are not designed for low bandwidth connectivity. Hence, these traditional synchronization techniques are totally inappropriate for use in wireless network applications.

### SUMMARY

The present invention teaches a method and an apparatus, embodied as a system, that may be used to effectively manage distributed processes and the data associated with those processes in an environment where communications between a server and a client are sporadic. According to one example method of the present invention, databases maintained by two processes may be synchronized by establishing a connection from a client to a server. A client typically receives a copy of an object instance instantiated by the server. Then, during any particular communications connection, an object instance identifier may be communicated to the server. Any changes made by the client to the copy of the object instance that it is using our then communicated as the “delta” to the server. This delta represents the changes that may have been made to the object instance prior to any particular “current” connection. It should be noted that a copy of an object instance may be communicated to a client so long as the client has not yet successfully received a copy of that object instance.

According to one illustrative variation of the present method, that deltas may be communicated to the server by determining if an object instance used by the client has experienced a state change. Typically, each object instance is capable of providing an identifiable delta-packet if it has experienced such a state change. A client process can retrieve the identifiable delta-packet and then conveyed to the server. According to this illustrative example method, a confirmation may be received from the server that the identifiable delta-packet has been received. Generally, any particular object instance is fashioned based on a priori knowledge of a particular operational domain. Accordingly, the object instance may behave in a manner consistent with this domain knowledge in order to determine when a state change, as reflected by a particular attribute within the object instance, occurs.

According to yet another alternative method of the present invention, a priori knowledge may be used to fashion and object that exhibits special behavior when a final state, again as reflected by a particular attribute within the object instance, has been reached. According to this example method, the object maintained and utilized by the client may be extinguished if it has reached its final state and all state changes have been properly acknowledged by the server.

In at least one derivative method of the present invention, a specific type of delta-packet is created according to which attribute of a particular object instance may have changed. A unique identifier and a special type indicator are associated with the delta-packet. The changed attribute is also stored in the delta-packet.

Once a delta-packet is created, it may be encoded into a request-response exchange. This exchange, according to one derivative method of the present invention, may be tailored to minimize the data bandwidth necessary to effect synchronization of an original of the object instance and a copy of the object instance. This may be accomplished by compressing the encoded delta-packet.

The present invention also comprises a system that embodies the method of the present invention. The system comprises a server and a client. Typically, the client establishes a connection with the server and communicates a unique identifier for an instance of an object that it may have received from the server during a previous connection session. Any changes that a process executing in the client may have made upon the copy of the object instance prior to establishing a “current” connection may also be conveyed to the server. The server, in order to create an object instance, may comprise an object instance process and an instance conveyance process. The object instance process typically creates a new instance of an object and assigns a unique identifier to the object instance. The instance conveyance process is responsible for conveying a copy of the object instance to a client if the client has not yet received a copy of the object instance.

In order to maintain synchronization, the server receives delta information from the client. Typically, the delta information is extracted from an instance of an object that has experienced a state change and that exists in the client. According to one alternative embodiment of the present invention, an object instance that exists in the client may comprise a delta-extraction method capable of generating delta information that can then be communicated to the server. In yet another embodiment, the instance of an object that exists in the client may experience a state change as reflected by a particular attribute of that object instance. Generally, a priori knowledge of the operational domain within which the system is operating is used to fashion the delta-extraction method that comprises an object instance. In yet to one additional embodiment of the present invention, the client may receive an acknowledgment that changes, i.e. a delta is properly received by the server.

### BRIEF DESCRIPTION OF THE DRAWINGS

The foregoing features, aspects, and advantages of the present invention will become better understood from the following detailed description of one embodiment of the invention with reference to the drawings, in which:

FIG. 1 is a data flow diagram depicting data synchronization between two processes using application level synchronization;

FIG. 2 is a flow diagram that depicts the creation of object instances according to one illustrative method of the present invention;

FIG. 3 is a message diagram that depicts communications occurring between a client and a server during the life cycle of an object instance as they operate in a system according to the present invention;

FIG. 4 is a pictorial representation of an object as used in one example embodiment of the present invention; and

FIG. 5 is a state diagram that demonstrates the transitional nature of object instances from one state to the next.

### DETAILED DESCRIPTION OF THE INVENTION

The present invention comprises a method for synchronizing data amongst two or more databases based on application-level domain knowledge. By applying this domain knowledge, the amount of information exchanged between a client and a server may be minimized. The applicable domain knowledge may further include temporal aspects of a process and may further comprise state-oriented depictions of transactions related to that process.

According to one illustrative embodiment of the present invention, the amount of data transferred between a client and server may be minimized by segregating the data into smaller, time-ordered modules. The form and content of these time-ordered modules may be driven by state-oriented depictions of process transactions. Accordingly, a-prior temporal knowledge about the process may be used as a basis for these state-oriented depictions. This temporal knowledge may also be used to predict connection availability and the frequency of state transitions that may occur during the application process. In a further refinement of an illustrative variation of the present invention, extensive status about each data transfer and/or synchronization attempt is maintained.

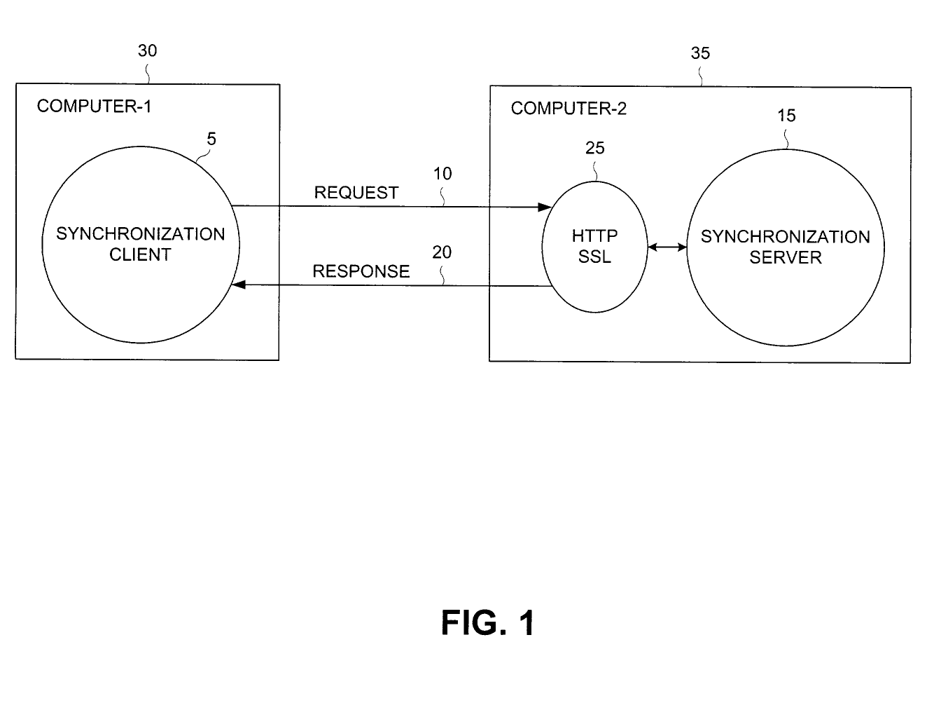

FIG. 1 is a data flow diagram depicting data synchronization between two processes using application level synchronization. Although the method of the present invention is independent of a communication protocol, one example method described herein is based upon commonly used network protocols. In at least one variation of this method, a client and a server communicate using TCP/IP protocol. The connection established may or may not exploit Secure Socket Layer (SSL) technology. Communication between a client process 5 and a server process 15 follows a request and response paradigm. Hence, a client process 5 issues a request 10. The server process 15 fulfills the request and creates a response 20 that is directed back to the client process 5. In this example method, an SSL component 25 is introduced in the request-response path in order to enhance transfer security. In some other derivative methods of the present invention, a transfer protocol such as HTTP 25 may be utilized in a server architecture. The sizes of any request and response buffers maintained by the client process 5 and the server process 15 are each configurable. In most applications, the size of these buffers will be determined by connection availability and the bandwidth available during any given connection.

According to the figure, the client process 5 and the server process 15 execute on disparate computer platforms, “Computer-1” 30 and “Computer-2” 35. In some applications, especially where a wireless hand-held device is being used in a business process, this will be a likely operating case for the present invention. It should be noted that the scope of the present invention should not be limited to processes executing in disparate computers and that both the client and server processes may be resident in the same physical platform.

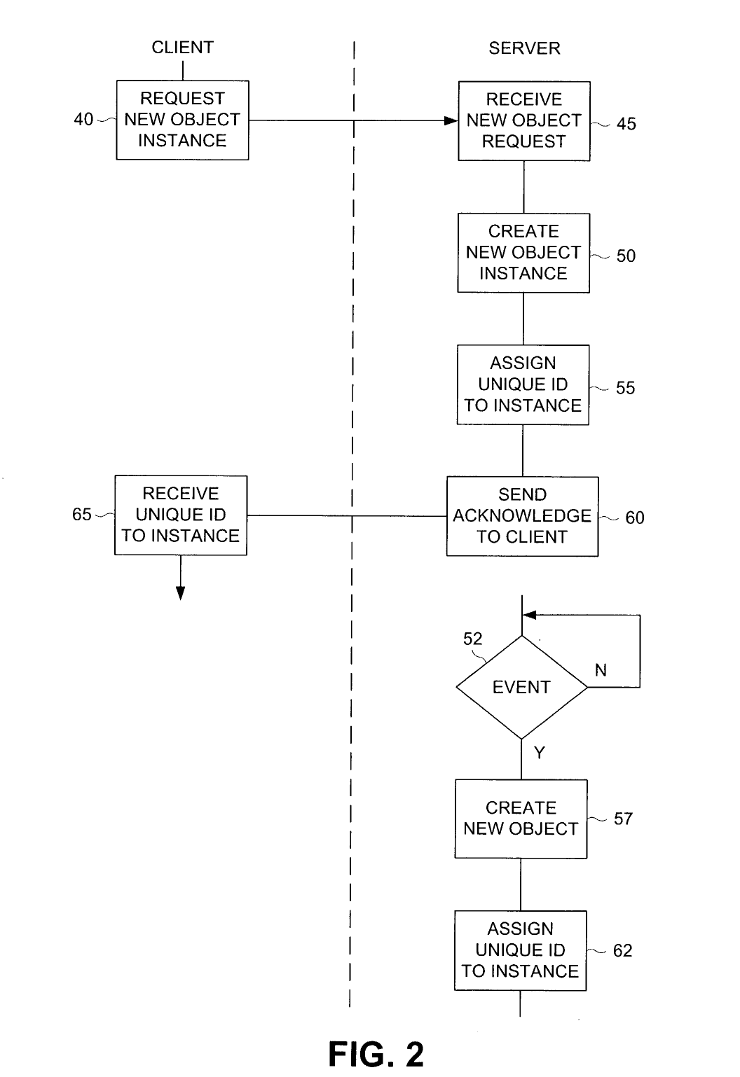

FIG. 2 is a flow diagram that depicts the creation of object instances according to one illustrative method of the present invention. According to this method, a new instance of a data object is created when a client process requests a new instance of an object (step 40). In an alternative method, a new object instance may be created in response to some other event perceived by the server (step 52). When such an event causes a new instance of an object to be created (step 57), it may be immediately associated with a specific client or clients. In such a creation scenario, any client requesting synchronization will receive a copy of any instances that are created for that client in response to such external events. In this derivative method, new instances are also assigned unique identifiers (step 62).

In terms of this disclosure, an object may comprise a template that comprises definitions of the data items that must be stored in an instance of the object. The object template may further comprise definitions of internal states that an instance of the object may adopt throughout its life. The object template may further comprise definitions of behaviors that dictate how an instance of the object may be manipulated. It should be noted that the object template might reside either with the synchronization client 5 or with the synchronization server 15. In those example embodiments where the object template resides with the client 5, the request issued by the client to the server for the creation of a new object instance may further comprise a template for an object.

Once the synchronization server receives the request for creation of a new object instance (step 45), it creates a new instance of the object (step 50). It should be noted that the request for creation of the new instance may be generated either by the client or a new instance may be created in response to an external event as described supra. The synchronization server, according to this illustrative method, may then assign a unique identifier to the newly created instance (step 55). The identifier may be referred to as an “ID”. After the newly created instance of the object is so identified, the synchronization server may send an acknowledgment back to the synchronization client 5 that comprises the ID (step 60). The synchronization client 5 receives the unique ID for the newly created instance (step 65). With this ID, the client process 5 may then subsequently request synchronization of that instance.

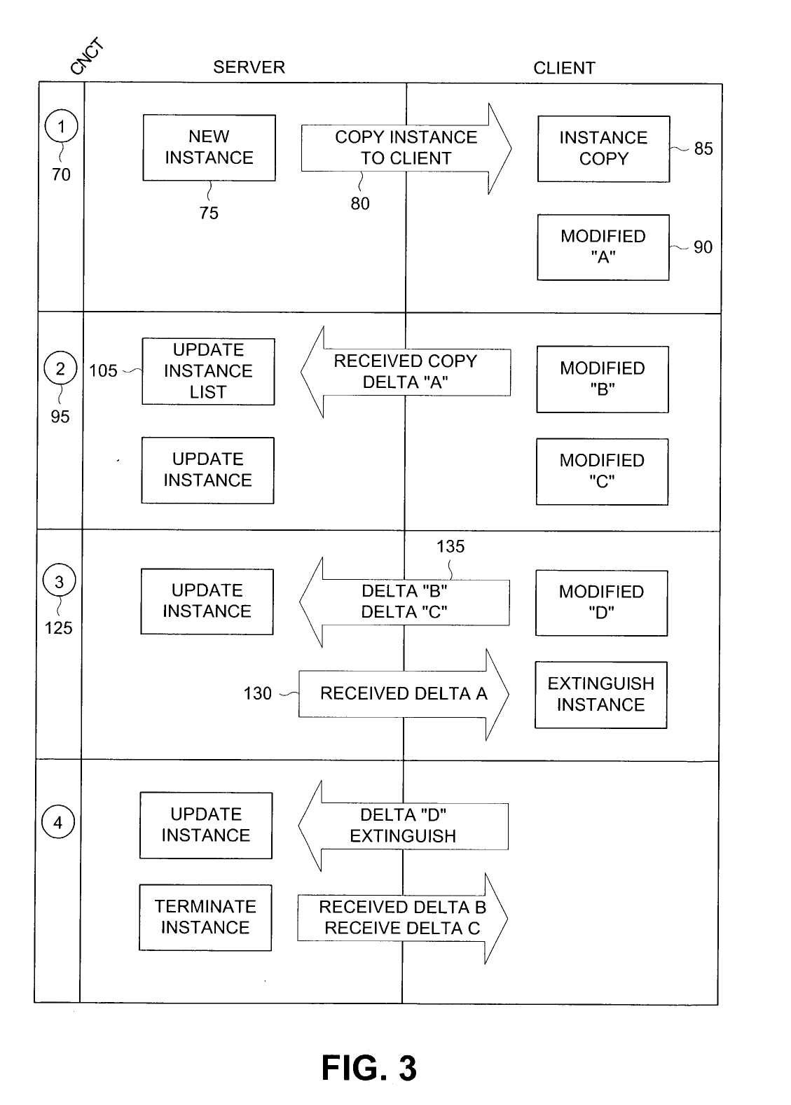

FIG. 3 is a message diagram that depicts communications occurring between a client and a server during the life cycle of an object instance as they operate in a system according to the present invention. After the server 15 creates an object instance, the client 5 may then request synchronization of that instance. In some variations of the present method, a first synchronization request may be required to initiate a copy of the instance in the client.

A synchronization request may comprise a client identifier. The synchronization request may further comprise a client password that may be used in an authentication process. The synchronization request may further comprise a connection identifier. In some embodiments of this method, the connection identifier may comprise the client identifier used in conjunction with a time stamp created by the client.

The synchronization request may further comprise a request buffer that is used to communicate specific synchronization data and status. The request buffer may further comprise a list of new instance IDs successfully received by the client during a previous connection and a list of changes made by the client to any object instances it uses. These changes are sometimes referred to as “deltas”.

During a first connection 70, the server 15 responds to the client synchronization request by attempting to convey copies of all new instances 75 created and not yet successfully conveyed to the client 5. If, during the first connection 70 the conveyance 80 is successful, the client will receive a copy 85 of new instances. The client may in fact modify its copy of the instance in some fashion. In this figure, the first set of modifications are referred to as “Modified A” 90.

In some embodiments of the present invention, the client 5 maintains a database table. One illustrative structure of a database table is presented below. The client 5 tracks object instances received from the server by making notations in the database table. In this illustrative method, the connection identifier (ID) is unique and is created by the client. In this example embodiment, a function accepts a current Connection ID as an argument and returns the preceding Connection ID. When the client forms the request, it selects all the Instance IDs for this specific Connection ID from the database.

| | | | |
|---|---|---|---|
| Connection ID | Instance ID | Serialized Instance | . . . |
| | | | . . . |

During a second connection 95, the server 15 parses a list of instance IDs 100 stored in the synchronization request buffer. This list represents instances of objects that a client has successfully received. The server 15 may update an instances list 105 to reflect what instances the client has received. Based on this information, the server determines which new object instances must still be sent to the client. This is done by comparing new instances that have been created for the client to those that the client has acknowledged as received. The server may then process any deltas that it receives from the client and updates the instances. In this example, “Delta A” is received and is used to update the server's copy of the object instance. The client conveys any deltas to the server that were not acknowledged by the server during a previous connection. During any given connection, the server 15 may attempt to copy to the client 5 any object instances that it has not yet successfully received.

In yet a subsequent connection, connection “3” 125 in the figure, the server 15 responds to the client 5 with an acknowledgment 130 that deltas were received. The client will then mark those deltas as having been successfully conveyed to the server. The server accepts any modifications made by the client 5 during the previous connection. In this example, the synchronization request 135 comprises two change packets “Delta B” and “Delta C”.

In one embodiment of the present invention, synchronization requests and responses conform to a normalized set of descriptor formats as described in the table below. However, the scope of the present invention should not be limited to those embodiments that utilize this set of descriptor formats.

| | | | Used by the | Used by the |
|---|---|---|---|---|
| | Maximum | | Client in the | Server in the |
| Field Name | Length | Field Type | Request | Response |
| Client ID | 3 | Alpha- | Yes | No |
| | | Numeric | | |
| Client | 8 | Alpha- | Yes | No |
| Password | | Numeric | | |
| Connection | 12 | Numeric | Yes | Yes |
| ID | | | | |
| Number of | 2 | Numeric | Yes | Yes |
| Instances | | | | |
| Instance ID | 8 | Numeric | Yes | Yes |
| Number of | 2 | Numeric | Yes | Yes |
| Deltas | | | | |
| Delta Buffer | Variable | Alpha- | Yes | No |
| | | Numeric | | |
| Instance | Variable | Alpha- | No | Yes |
| Buffer | | Numeric | | |

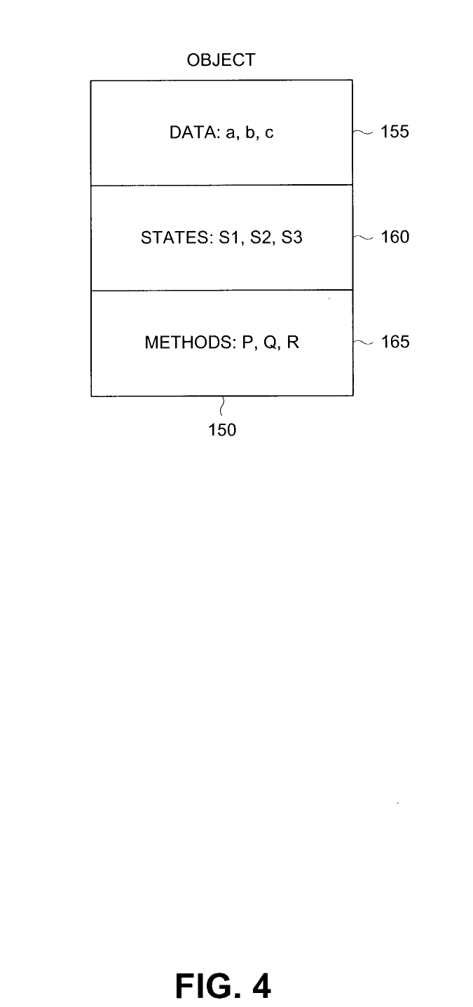

FIG. 4 is a pictorial representation of an object as used in one example embodiment of the present invention. An object comprises a template 150 of definitions for a self-contained packet of information. According to this example embodiment, an object may comprise definitions for data or variables 155. The object template may further comprise definitions for one or more attributes that describe its properties and state variables 160. Any methods 165 that describe the behavior of an object instance may further comprise the object template.

An instance is an instantiation of an object. An application program or other process may operate upon a local copy of the instance. These operations may comprise addition, deletion or modification of data or variables in the instance. Other operations may comprise modifications of attributes affecting the state of an object instance

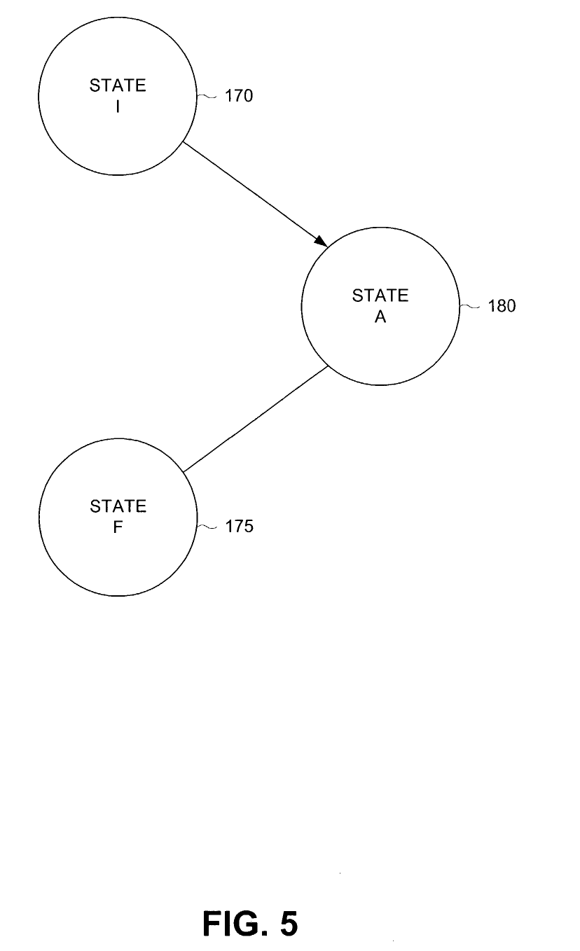

FIG. 5 is a state diagram that demonstrates the transitional nature of object instances from one state to the next. In this example embodiment, each object instance can assume one of at least two finite states. Object instance states and transitions rules may be defined as part of the synchronization process. An instance has at least two states—initial (S-I) 170 and final (S-F) 175. It may have one or more intermediate states (S-A) 180. The states of each object instance and the transition rules may be varied according to each application.

In most embodiments, each object template will be designed to comprise a plurality of state definitions. One or more behaviors may be affiliated with each of these states. Each state may comprise at least one delta-extraction method. The delta-extraction method defines a procedure used to identify any changes made to any of the data, variables, state changes or other attributes that define the complexion of any object instance. The delta-extraction method may be invoked in response to a synchronization trigger for the instance. The delta-extraction method prepares a delta-packet for the instance that is identified by the instance ID. Creation of the delta-extraction, or any other method may be based on an analysis of the operating domain that a database system is intended to serve.

Different methods in the object instance may be employed to cause object instances to transition from one state to the next. For example, when an instance is in an initial state (S-1) 170, it may be proper for a state transition method to move the instance to an intermediate state (S-A) 180. The definition of methods that cause such state transitions may be based on a priori knowledge of the operating domain that a database system is supporting. Some state transitions occur as a result of changes in the attributes and/or data and/or variables in the instance. When these state changes occur, synchronization between the master instance in a server and a corresponding copy instance in the client may be initiated. Once an object instance is in a final state and is entirely synchronized with the server, it will not be synchronized again. It is said to be extinguished.

When two object instances are synchronized, the attribute value of one object replaces the same attribute value of the other. This effects two-way synchronization. The present invention defines special rules for two-way synchronization. Each attribute may be assigned a synchronization property. These properties determine which object instance has precedence over the other. In this example embodiment, attributes can assume one of three property types; cardinal, mutable, or fixed.

The matrix shown below illustrates how property types are used when two object instances are synchronized. In this example, “a1” and “a′1” are identical attributes belonging to two different object instances. In this table, the first column represents the properties of “a1” and the first row that of “a′1”. For example, if “a1” is cardinal and “a′1” is mutable, then the value of “a1” is used for synchronization. These properties are assigned during the object instance creation and copying process. More importantly, the such a synchronization property matrix can be extended to incorporate more complex synchronization rules.

| “a1”\“a′1” | Cardinal | Mutable | Fixed |
|---|---|---|---|
| Cardinal | — | a1 | — |
| Mutable | a′1 | a1 or a′1 | — |
| Fixed | — | — | — |

When a transition occurs in an instance's state, the values of cardinal attributes form the delta for that object. The state transition rules and methods defined for the instance describe what attribute values are to be used to compute the delta. When a rule activates its action, the rule runs a procedure to calculate the delta and stores it in a queue.

In some alternative methods according to the present invention, data-packets are created that depict changes in an instance of an object. In these alternative embodiments, a different type of delta-packet is created based on what attribute has been changed in the object instance. In these cases, the delta-packet is augmented by a type-indicator. The type-indicator can then be used by the server to properly interpret the contents of a delta-packet.

Once delta-packets are created, this illustrative method provides for an encoding process so that the delta-packet can be embodied into a request-response exchange. In this example method, the format of the request-response exchange is tailored to reduce data bandwidth by considering factors such as availability and service interruptions together with a priori domain knowledge of the operating environment supported by the database system. To further exploit the available bandwidth, the request-response exchange may be compressed in a bit-wise fashion.

### Alternative Embodiments

While this invention has been described in terms of a preferred embodiment, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents. Some, but by no means all of the possible alternatives are described herein.

I claim:

1. A method for synchronizing databases maintained by two processes comprising the steps of:
establishing a connection from a client to a server;
communicating an object instance identifier to the server for an object instance received from the server during a previous connection; and
communicating a delta to the server that reflects changes made to the object instance prior to the current connection.

2. The method of claim 1 further comprising the step of conveying a copy of an object instance to a client if the client has not yet successfully received that instance copy.

3. The method of claim 1 wherein the step of communicating a delta to the server comprises:
determining which object instance in the client has experienced a state change;
retrieving an identifiable delta-packet from the object instance that has experienced a state change;
conveying the identifiable delta-packet to the server; and
receiving confirmation that that the identifiable delta-packet has been received by the server.

4. The method of claim 3 wherein the step of determining which object instance in the client has experienced a state change comprises the steps of:
determining which attribute within an object instance is associated with a state change based on a priori knowledge of the domain; and
determining if the attribute associated with the state change has been modified.

5. The method of claim 4 further comprising the steps of:
determining if the state of the object instance has reached a final state based on a priori knowledge of the domain and the object attributes that have changed; and
extinguishing the object when it reaches a final state and all state changes have been acknowledged by the server.

6. The method of claim 3 wherein the step of retrieving an identifiable delta-packet from an object instance that has experienced a state change comprises the steps of:
creating a different type of delta-packet based on which attribute has changed;
creating a unique identifier for the delta-packet;
associating a delta-type indicator to the delta-packet based on which attribute has changed; and
storing the changed attribute into delta-packet.

7. The method of claim 3 wherein the step of conveying the identifiable delta packet to the server comprises the steps of:
encoding the delta-packet into a request and response exchange wherein the request and response exchange are tailored to minimize data bandwidth requirements.

8. The method of claim 7 further comprising the step of compressing the encoded delta-packet.

9. A method for creating database objects comprising the steps of:
creating within a server database a new instance of a database object;
uniquely identifying the new instance of the database object; and
communicating a unique instance identifier to a process for which the new instance of the database object was created.

10. A database synchronization system comprising:
server; and
client that establishes a current connection with the server and communicates to the server a unique identifier for an instance of an object that was received from the server during a previous connection and wherein the client communicates to the server changes made to the instance of the object prior to the current connection.

11. The database synchronization system of claim 10 wherein the server comprises:
object instance process that creates an instance of an object and assigns a unique identifier to the object instance; and
instance conveyance process that conveys a copy of the object instance to a client if the client has not received the object instance.

12. The database synchronization system of claim 10 wherein the changes communicated by the client to the server are based on delta information extracted from an instance of an object existing in the client that and wherein that instance of the object has experienced a state change.

13. The database synchronization system of claim 12 wherein an object instance comprises a delta-extraction method that generates delta information that can be communicated to a server.

14. The database synchronization system of claim 12 wherein delta information is extracted from an instance of an object if the state change experienced by that instance is based on a change in an attribute of that object that should be interpreted as a change in state based on a priori knowledge of an operational domain serviced by the system.

15. The database synchronization system of claim 10 wherein the client further receives an acknowledgement that changes were received by the server.
